(19) United States
(12) Patent Application Publication
(10) Pub. No.: US 2026/0150002 A1
(43) Pub. Date: May 28, 2026

(54) SYSTEMS AND METHODS FOR NATIVE LOW LATENCY, LOW LOSS, AND SCALABLE THROUGHPUT (L4S) OPERATION IN TELECOMMUNICATIONS NETWORKS

(71) Applicant: T-MOBILE INNOVATIONS LLC, Overland Park, KS (US)

(72) Inventors: Zheng FANG, McLean, VA (US); Zheng CAI, Fairfax, VA (US)

(21) Appl. No.: 18/956,901

(22) Filed: Nov. 22, 2024

(51) Int. Cl. H04W 28/02; H04L 69/22; H04W 28/06

(52) U.S. Cl. CPC H04W 28/0289; H04L 69/22; H04W 28/0284; H04W 28/06

(57) ABSTRACT

Systems and methods for native Low Latency, Low Loss, and Scalable Throughput (L4S) operation in telecommunications networks are provided. In an example, a method includes marking, with a first component of a telecommunications network, one or more bits of an outer Internet Protocol (IP) header of a packet to indicate that the packet includes L4S traffic or to indicate that congestion is experienced for the telecommunications network. The outer IP header encapsulates an inner packet. The method further includes transmitting the packet to a second component of the telecommunications network.

### SUMMARY

The present disclosure is directed, in part, to native Low Latency, Low Loss, and Scalable Throughput (L4S) operation in a telecommunications network substantially as shown in and/or described in connection with at least one of the figures, and as set forth more completely in the claims.

A high-level overview of various aspects of the present technology is provided in this section to introduce a selection of concepts in a simplified form that are further described below in the detailed description. This summary is not intended to identify key features or essential features of the claimed subject matter, nor is it intended to be used in isolation as an aid in determining the scope of the claimed subject matter.

In aspects set forth herein, and at a high level, the technology described herein may include marking one or more bits (e.g., Explicit Congestion Notification (ECN) or L4S bits) of an outer Internet Protocol (IP) header of packets to indicate that congestion is experienced for the telecommunications network used to transmit the packets. The outer IP header of the packets encapsulate inner packets (e.g., inner IP packet or Stream Control Transmission Protocol (SCTP) packet) transmitted between components of a telecommunications network. Component(s) of the telecommunications network may implement one or more processes for L4S congestion control based on generating and/or receiving the packets with the one or more bits of the outer IP header marked to indicate that congestion is experienced.

### BRIEF DESCRIPTION OF THE DRAWINGS

Aspects of the present disclosure are described in detail herein with reference to the attached Figures, which are intended to be exemplary and non-limiting, wherein:

FIG. 1 is a diagram illustrating an example network environment for use in accordance with aspects herein;

FIG. 2 is a block diagram illustrating example network components for use in accordance with aspects herein;

FIG. 3 is flow chart illustrating an example method for native L4S operation in a telecommunications network, in accordance with aspects herein;

FIG. 4 is flow chart illustrating an example method for native L4S operation in a telecommunications network, in accordance with aspects herein; and

FIG. 5 is a diagram illustrating an example computing environment, in accordance with aspects herein.

### DETAILED DESCRIPTION

The subject matter of embodiments of the present disclosure is described with specificity herein to meet statutory requirements. However, the description itself is not intended to limit the scope of this patent. Rather, the inventors have contemplated that the claimed subject matter might be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

By way of background, L4S technology is being considered in the telecommunications industry because it enables low latency, high-rate communications with dynamic rate adaptation and a stable Quality of Experience (QoE) even when the network is loaded. Some important features of L4S include ECN, Dual Queue Coupled Active Queue Management (AQM), and scalable congestion control, which reduces latency and packet loss considerably. Real-time dynamic rate adaptation algorithms at the application layer may be used for L4S to stabilize the QoE. Implementing L4S may improve performance for time critical applications (e.g., extended reality, machine learning, artificial intelligence, etc.) provided using a telecommunications network, especially when the congestion control algorithms are designed for such use cases.

Conventionally, endpoints (e.g., client and server) may utilize L4S over-the-top of a telecommunications network without network support. The L4S congestion control algorithm is implemented on a per application basis and both endpoints need to be L4S enabled and aware. The rate adaptation features of L4S are implemented without network support using a feedback mechanism (e.g., ECN-Echo) that notifies the server that congestion is experienced. For example, the receiving client measures latency and bitrate and feeds this information back to the server using an out-of-band protocol. This approach places a burden on the legacy applications to adopt L4S at the application layer of the client devices and does not perform well using best-effort Quality of Service (QoS) flows over public wireless telecommunications networks (e.g., 5G networks).

Another approach utilizes some support from a wireless telecommunications network for rate adaptation between the client and server. This approach may include using dedicated QoS flows/bearers for L4S traffic and marking bits in the inner IP packet communicated via a GTP tunnel using a component of the telecommunications network (e.g., an access node) that is serving the L4S-capable packet flow. For example, the component of the telecommunications network may mark the ECN bits of the inner IP packets (e.g., inner IP headers and/or TCP headers) upon detecting congestion, and the receiving client relays this in-band information provided by the component of the telecommunications network back to the server for rate adaptation. For time critical applications, this approach is typically implemented in the radio access network (e.g., at the base station), which marks the IP headers and/or TCP headers of the inner IP packets, which requires recomputing the checksum of the IP headers and/or TCP headers of the inner IP packets where the marking occurs prior to transmitting the packets to the client device (e.g., user equipment). While this approach may perform better than the other conventional approach that does not use network support, this approach requires substantial computing resources at the base station, which may not be currently available in networks and necessitate expensive and time consuming upgrades to infrastructure. Further, this approach may still place a burden on the legacy applications to adopt L4S at the application layer for the client devices.

Unlike conventional solutions, the present disclosure is directed to implementing native L4S operation in a telecommunications network without marking inner packets (e.g., inner IP packets or inner SCTP packets). One or more components of the telecommunications network may mark one or more bits (e.g., ECN bits) of an outer IP header of a packet that encapsulates an inner packet (e.g., inner IP packet or an inner SCTP packet) communicated via the telecommunications network. For example, the components of the telecommunications network may mark one or more bits (e.g., ECN or L4S bit(s)) of the outer IP header of a General Packet Radio Service (GPRS) Tunneling Protocol (GTP) packet or the outer IP header that encapsulates an SCTP packet. The marking may indicate that congestion is experienced for the telecommunications network based on a level of congestion (e.g., exceeding a threshold). Components of the telecommunications network that generate and/or receive the marked packets may implement one or more process for L4S congestion control based on the marking that indicates that congestion is experienced for the telecommunication network. By marking the outer IP header rather than marking the inner packet (e.g., IP header or TCP header), L4S congestion control may be implemented by the telecommunications network without requiring deep packet inspection, modifying the inner packet, or recomputing the checksum(s) for the inner packet when congestion is detected within the telecommunications network. This may significantly reduce the computing resources required at the base station to support native L4S operation for the telecommunications network.

As described above, conventionally both endpoints need to be L4S aware and enabled to implement end-to-end L4S operation. However, this may be burdensome to implement because a large number of endpoints (e.g., clients) may need to be updated to enable this functionality. In some embodiments, one or more components of the telecommunications network in the present disclosure may act as a proxy for some of the endpoints (e.g., clients) and provide L4S feedback to the transmitting endpoint (e.g., server) indicating that congestion is experienced for the telecommunications network. This enables the server to perform L4S rate adaptation without the clients being L4S enabled or aware, which may reduce the burden on updating applications and particularly so for applications operating on multi-generational devices.

In one aspect, an apparatus is provided. The apparatus includes one or more processors and one or more computer-readable media storing computer-usable instructions that, when executed by the one or more processors, cause the one or more processors to perform a method. The method includes receiving a packet that includes an outer IP header that encapsulates an inner packet. The method also includes determining whether one or more bits of the outer IP header indicate congestion is experienced for a telecommunications network. Further, the method includes implementing one or more processes for L4S congestion control based at least on the one or more bits of the outer IP header indicating that congestion is experienced for the telecommunications network.

In another aspect, an apparatus is provided. The apparatus includes one or more processors and one or more computer-readable media storing computer-usable instructions that, when executed by the one or more processors, cause the one or more processors to perform a method. The method includes marking one or more bits of an outer IP header of a packet to indicate that congestion is experienced in a telecommunications network that includes the apparatus. The outer IP header encapsulates an inner packet. The method also includes transmitting the packet to another component of the telecommunications network.

In yet another aspect, a method is provided. The method includes marking, with a first component of a telecommunications network, one or more bits of an Explicit Congestion Notification field of an outer IP header of a packet to indicate that the packet includes L4S traffic or to indicate that congestion is experienced for the telecommunications network. The outer IP header encapsulates an inner packet. The method also includes transmitting the packet to a second component of the telecommunications network.

Various technical terms, acronyms, and shorthand notations are employed to describe, refer to, and/or aid the understanding of certain concepts pertaining to the present disclosure. Unless otherwise noted, said terms should be understood in the manner they would be used by one with ordinary skill in the telecommunication arts. An illustrative resource that defines these terms can be found in Newton's Telecom Dictionary, (e.g., 32d Edition, 2022).

As used herein, the term “base station” (used for providing UEs with access to the telecommunication services) or “access node” generally refers to one or more base stations, access nodes, RRUs control components, and the like (configured to provide a wireless interface between a wired network and a wirelessly connected user device). A base station may comprise one or more access nodes (e.g., eNB, gNB, and the like) that are configured to communicate with user devices. In some aspects, the base station may include one or more band pass filters, radios, antenna arrays, power amplifiers, transmitters/receivers, digital signal processors, control electronics, GPS equipment, and the like.

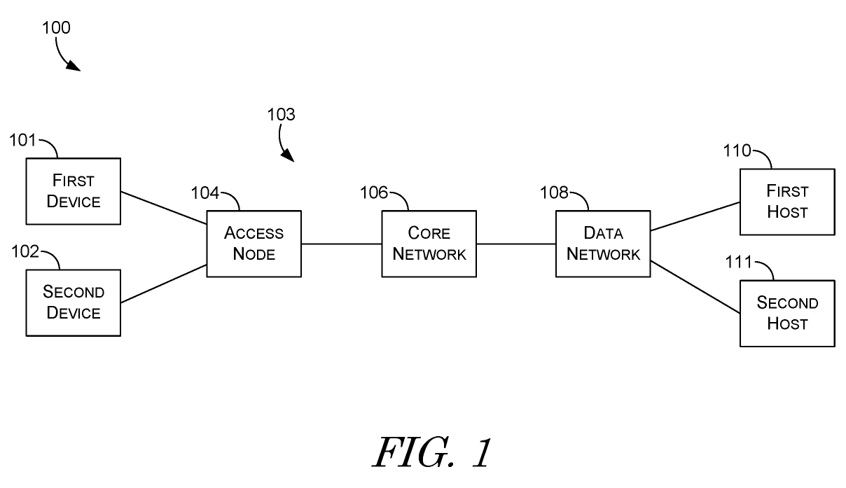

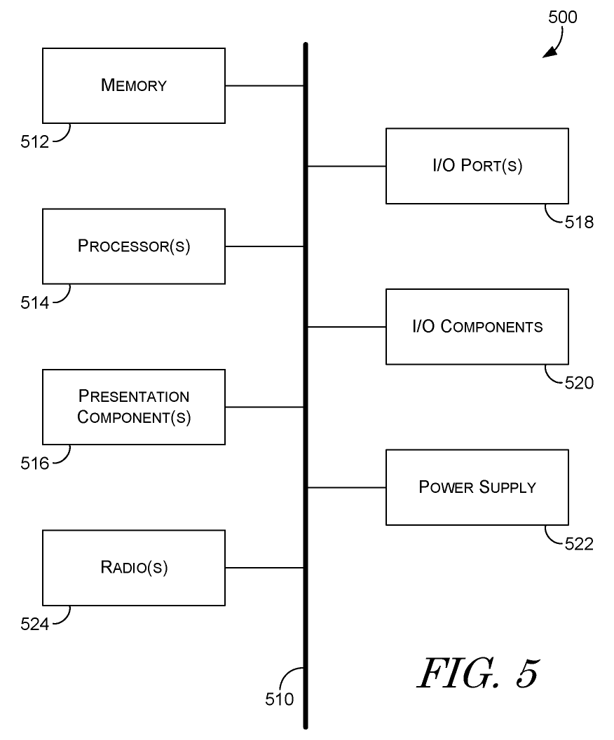

A “user device,” as used herein, is a device that has the capability of using a wireless communications network, and may also be referred to as a “mobile device,” “user equipment,” “wireless communication device,” or “UE.” A user device, in some aspects, may take on a variety of forms, such as a PC, a laptop computer, a tablet, a mobile phone, a PDA, a server, or any other device that is capable of communicating with other devices (e.g., by transmitting or receiving a signal) using wireless communication. A user device may be, in an embodiment, similar to the first device 101 or the second device 102 described herein with respect to FIG. 1. A user device may also be, in another embodiment, similar to the computing device 500, described herein with respect to FIG. 5.

A user device may additionally include internet-of-things devices, such as one or more of the following: a sensor, controller (e.g., a lighting controller, a thermostat, etc.), appliances (e.g., a smart refrigerator, a smart air conditioner, a smart alarm system, etc.), other internet-of-things devices, or one or more combinations thereof. Internet-of-things devices may be stationary, mobile, or both. In some aspects, the user device is associated with a vehicle (e.g., a video system in a car capable of receiving media content stored by a media device in a house when coupled to the media device via a local area network). In some aspects, the user device comprises a medical device, a location monitor, a clock, other wireless communication devices, or one or more combinations thereof.

A “Fixed Wireless Access (FWA) device,” as used herein, is a device that is part of an FWA system, which includes the base station (or access point) and the FWA device. The FWA device is installed at the user's premises. It communicates wirelessly with the base station to provide internet connectivity to the end-user devices, such as computers, smartphones, smart TVs, and other internet-enabled devices within the premises. The FWA device serves as the intermediary between the user’s internal network and the base station. It receives data from the base station and transmits it to the user’s devices and vice versa. For optimal performance, FWA devices are usually installed in locations with clear line-of-sight to the base station, such as rooftops or external walls.

Embodiments of the technology described herein may be embodied as, among other things, a method, system, or computer-program product. Accordingly, the embodiments may take the form of a hardware embodiment, or an embodiment combining software and hardware. An embodiment takes the form of a computer-program product that includes computer-useable instructions embodied on one or more computer-readable media that may cause one or more computer processing components to perform particular operations or functions.

Computer-readable media include both volatile and nonvolatile media, removable and non-removable media, and contemplate media readable by a database, a switch, and various other network devices. Network switches, routers, and related components are conventional in nature, as are means of communicating with the same. By way of example, and not limitation, computer-readable media comprise computer-storage media and communications media.

Computer-storage media, or machine-readable media, include media implemented in any method or technology for storing information. Examples of stored information include computer-useable instructions, data structures, program modules, and other data representations. Computer-storage media include, but are not limited to RAM, ROM, EEPROM, flash memory or other memory technology, CD-ROM, digital versatile discs (DVD), holographic media or other optical disc storage, magnetic cassettes, magnetic tape, magnetic disk storage, and other magnetic storage devices. These memory components can store data momentarily, temporarily, or permanently.

Communications media typically store computer-useable instructions – including data structures and program modules – in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

Turning to FIG. 1, FIG. 1 is a diagram illustrating an example network environment 100 in which aspects of native L4S operation in a telecommunications network may be implemented. Such a network environment is illustrated and designated generally as network environment 100. Network environment 100 is but one example of a suitable network environment and is not intended to suggest any limitation as to the scope of use or functionality of the disclosure. Neither should the network environment 100 be interpreted as having any dependency or requirement relating to any one or combination of components illustrated.

As shown in FIG. 1, network environment 100 comprises a first device 101, a second device 102, a telecommunications network 103 including an access node 104 and a core network 106, a data network 108, a first host 110, and a second host 111. It should be noted that although a particular number of devices and nodes are shown in FIG. 1, the network environment 100 may include a different number of devices, nodes, and/or other components. More or fewer devices, nodes, and/or components are possible and contemplated, including in consolidated or distributed form.

The first device 101 and the second device 102 may comprise a user device or a FWA device. The first device 101 and the second device 102 may comprise any device employed by an end-user to communicate with a telecommunications network 103, such as a wireless telecommunications network. The first device 101 and the second device 102 may, in general, comprise forms of equipment and machines such as but, not limited to, Internet-of-Things (IoT) devices and smart appliances, autonomous or semi-autonomous vehicles including cars, trucks, trains, aircraft, urban air mobility (UAM) vehicles and/or drones, industrial machinery, robotic devices, exoskeletons, manufacturing tooling, thermostats, locks, smart speakers, lighting devices, smart receptacles, controllers, mechanical actuators, remote sensors, weather or other environmental sensors, wireless beacons, cash registers, turnstiles, security gates, or any other smart device. That said, in some embodiments, the first device 101 and the second device 102 may include computing devices such as, but not limited to, handheld personal computing devices, cellular phones, smartphones, tablets, laptops, and similar consumer equipment, or stationary desktop computing devices, workstations, servers and/or network infrastructure equipment. As such, the first device 101 and the second device 102 may be mobile UEs or stationary UEs. The first device 101 and the second device 102 may include one or more processors, and one or more non-transient computer-readable media for executing code to carry out the functions of the first device 101 and the second device 102 described herein. The computer-readable media may include computer-readable instructions executable by the one or more processors. In some embodiments, the first device 101 and the second device 102 may be implemented using a computing device 500 as discussed below with respect to FIG. 5.

Access nodes, such as the access node 104, are often individually referred to as a radio access network (RAN) and/or a wireless communication base station system. In the embodiment shown in FIG. 1, the access node 104 may function as an access node via which the devices 101 and 102 within coverage area of the access node 104 can wirelessly access services of the core network 106, such as telecommunications and data connectivity.

In the context of fourth generation (4G) Long Term Evolution (LTE), the access node 104 may be referred to as an eNodeB, or eNB. In the context of fifth generation (5G) New Radio (NR), the access node 104 may be referred to as a gNodeB, or gNB. Access nodes may be terrestrial or extraterrestrial. Other terminology may also be used depending on the specific implementation technology. As such, in some embodiments, the network environment 100 comprises, at least in part, a wireless communications network, such as the core network 106. Further, the core network 106 communicates with the data network 108.

In some embodiments, the access node 104 may comprise a multi-modal network (for example comprising one or more multi-modal access devices) where multiple radios supporting different systems are integrated into the radio of the access node 104. Such a multi-modal RAN may support a combination of 3GPP radio technologies (e.g., 4G, 5G and/or 6G) and/or non-3GPP radio technologies.

The core network 106 may be a component of a wireless communications network that provides one or more wireless network services to one or more devices (e.g., the first device 101 and the second device 102) within the coverage areas of a plurality of nodes, including the access node 104. In particular, the core network 106 provides combinations of network services to the devices 101 and 102 for at least one public land mobile networks (PLMNs) that the devices 101 and 102 may attach to via channels of one or more RF bands (referred to herein as RF band layers).

The network environment 100 is generally configured for wirelessly connecting the devices 101 and 102 to other devices via the access node 104, via other RAN and/or other local wireless cellular access points, and/or via other telecommunications networks or a public switched telephone network (PSTN), for example. The network environment 100 may be generally configured, in some embodiments, for wirelessly connecting the devices 101 and 102 to data or services that may be accessible on one or more application servers or other functions, nodes, or servers (such as services provided by servers of the data network 108, for example). The data network 108, in aspects, may be private data networks or a public data networks (e.g., the Internet).

In the example shown in FIG. 1, the first host 110 communicates with the first device 101. The first host 110 may comprise a server for an application or other service that requires low-latency and high-rate communications, and the first device 101 may be a client that communicates with the server via the telecommunications network 103 including the access node 104 and core network 106. For example, the first host 110 may comprise an application server that supports real-time video, augmented reality (AR), virtual reality (VR), cloud gaming, or the like, and the first device 101 includes a corresponding client application. To enable a better experience for the user using the application executing on the first device 101, the first host 110 may support L4S to reduce the latency and improve throughput for the application traffic.

In the example shown in FIG. 1, the second host 111 communicates with the second device 102. The second host 111 may comprise a server for an application or other service that does not require low-latency or high-rate communications, and the second device 102 may be a client that communicates with the server via the telecommunications network including the access node 104 and core network 106. For example, the second host 111 may comprise a web server and the second device 102 may access web pages using a web browser on the second device 102. In some examples, the second host 111 does not support L4S for these communications.

The L4S traffic is separated from non-L4S traffic in the network environment 100. The first host 110 may mark user IP packets being sent to the first device 101 as being L4S-capable in order to distinguish these user IP packets from other user IP packets being transmitted via the telecommunications network 103. In some examples, the IP header of the L4S traffic between the first host 110 and the first device 101 may include a first Differentiated Services Code Point (DSCP) value, and the IP header of the non-L4S traffic between the second host 111 and the second device 102 may be associated with a second DSCP value. The first DSCP value and the second DSCP value may be associated with one or more QoS identifiers used for various flows or bearers for the telecommunications network 103.

In some embodiments, the first host 110 may mark the user IP packets being sent to the first device 101 using codepoints of the ECN field in the IP header of the user IP packet. For example, the first host 110 may mark bits of the ECN field as “01” corresponding to the codepoint ECT(1) of the inner IP header to indicate that the traffic from the first host 110 is L4S-capable. Since the traffic between the second host 111 and the second device 102 is non-L4S traffic, the second host 111 does not mark the user IP packets being sent to the second device 102 as being L4S-capable, and the bits of the ECN field of the IP header of the user IP packet include “00” corresponding to the codepoint Not-ECT, which is indicative of non-L4S traffic. The first host 110 and the second host 111 transmit the user IP packets to the first device 101 and the second device 102, respectively, via one or more components of the telecommunications network 103. The one or more components of the telecommunications network 103 implement native L4S operation as discussed herein.

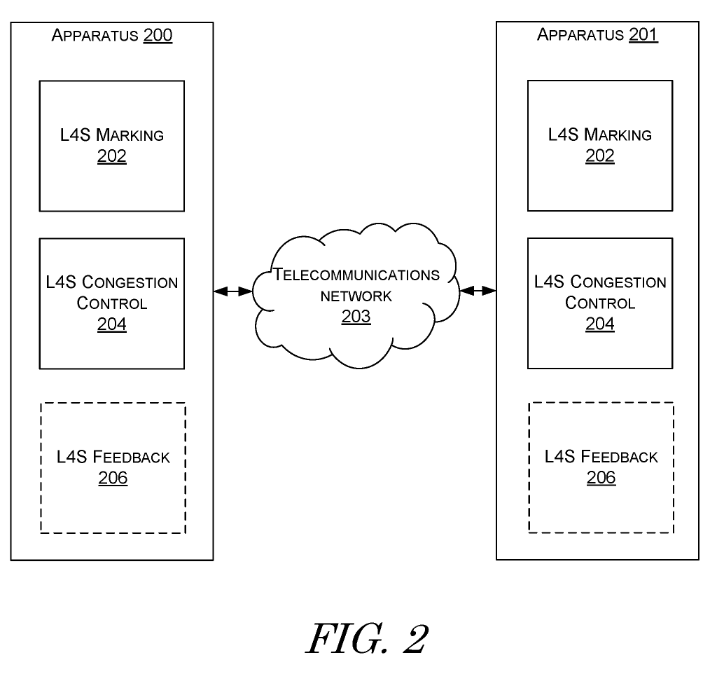

Referring now to FIG. 2, FIG. 2 is a block diagram illustrating example apparatuses 200 and 201 for use in native L4S operation implementations of the present disclosure. In some embodiments, the first apparatus 200 and the second apparatus 201 may comprise components of the telecommunications network 103 (e.g., the access node 104 or a component of the core network 106) shown in FIG. 1. The first apparatus 200 and the second apparatus 201 are included in and may communicate via the telecommunications network 203, which may comprise at least part of the telecommunications network 103.

In some embodiments, the first apparatus 200 or the second apparatus 201 may receive pass-through traffic from outside the telecommunications network 103 (e.g., the user IP packets from the first host 110 and the second host 111). This pass-through traffic received by the first apparatus 200 or the second apparatus 201 may be sent through the telecommunications network 103 via one or more GPRS Tunneling Protocol (GTP) tunnels. A GTP tunnel is a virtual communication path established between two components of the telecommunications network 103. In some embodiments, a GTP tunnel exists between the access node 104 and a component of the core network 106 (e.g., a user plane function (UPF) or Packet Data Network (PDN) gateway (PGW)) and facilitates the transmission of user data between these components of the telecommunications network 103. The first apparatus 200 or the second apparatus 201 (or other components of the telecommunications network 103) may encapsulate the user IP packets within an outer IP header, a User Datagram Protocol (UDP) header, and a GTP header (e.g., GTP-U header) to form GTP packets, and GTP packets may be transmitted via one or more GTP tunnels.

In some embodiments, the first apparatus 200 or the second apparatus 201 may also receive or generate signaling traffic that is internal to the telecommunications network 103. This internal signaling traffic received or generated by the first apparatus 200 or the second apparatus 201 may comprise Stream Control Transmission Protocol (SCTP) packets, which are encapsulated within an outer IP header prior to transmission throughout the telecommunications network 103. The first apparatus 200 or the second apparatus 201 (or other components of the telecommunications network 103) may encapsulate the SCTP packets within the outer IP header.

Some of the pass-through traffic or the internal signaling traffic may be L4S traffic and some of the pass-through traffic or the internal traffic may be non-L4S traffic. The first apparatus 200 and the second apparatus 201 may each include a first queue for the L4S traffic and a second queue for the non-L4S traffic. In some embodiments, the L4S traffic is provided to the first queue and the non-L4S traffic is provided to the second queue (e.g., based on DSCP values, codepoints of the ECN field, and/or other indicators of the type of traffic).

In the example shown in FIG. 2, the first apparatus 200 includes an L4S marking function 202 that may mark one or more bits in the outer IP headers that encapsulate inner packets (e.g., inner IP packets or SCTP packets) that include L4S traffic based on a level of congestion for the telecommunications network 203. In some embodiments, the first apparatus 200 may determine the level of congestion for the telecommunications network 203 based on one or more network characteristics. The level of congestion may be determined based on a queue delay, a channel quality indicator (CQI), and/or other factors indicative of congestion for the telecommunications network 203. In some embodiments, the first apparatus 200 receives an indication of a level of congestion from another component (e.g., another component of the telecommunications network 203). The L4S marking function 202 of the first apparatus 200 may not mark one or more bits in the outer IP headers that encapsulate that encapsulate inner packets that include non-L4S traffic.

In some embodiments, the L4S marking function 202 of the first apparatus 200 may mark the packets that include L4S traffic using a first codepoint or a second codepoint of the ECN field in the outer IP headers that encapsulate the inner packets depending on whether the level of congestion for the telecommunications network 203 exceeds a threshold. The threshold may be predetermined or adapted based on performance requirements for the L4S traffic, the level of congestion of the telecommunications network 203, or other factors.

The L4S marking function 202 of the first apparatus 200 may mark the packets that include L4S traffic using the first codepoint of the ECN field in the outer IP header to indicate that congestion is experienced in the telecommunications network 203 when the level of congestion for the telecommunications network 203 exceeds a threshold. For example, the L4S marking function 202 may mark the bits in the ECN field of the outer IP header to be “11” corresponding to the codepoint CE in order to indicate that congestion is experienced in the telecommunications network 203. However, the L4S marking function 202 of the first apparatus 200 need not mark the inner packets to indicate that congestion is experienced for the telecommunications network 203 (e.g., using the ECN field of the inner IP packet or the SCTP packet).

When the first apparatus 200 encapsulates the inner packets, the L4S marking function 202 of the first apparatus 200 may also mark the packets that include L4S traffic using the second codepoint of the ECN field in the outer IP header to indicate that the traffic in the packets is L4S traffic even when the level of congestion for the telecommunications network 203 does not exceed a threshold. For example, the L4S marking function 202 of the first apparatus 200 may mark the bits in the ECN field of the outer IP header to be “01” corresponding to the codepoint ECT(1) to indicate L4S-capable transport. In some embodiments, if the packets that include L4S traffic are transmitted using separate QoS flows/bearers, then the marking of packets with the second codepoint may not be implemented or needed.

The L4S marking function 202 of the first apparatus 200 does not mark the packets that include non-L4S traffic. In some embodiments, a default codepoint of the ECN field in the outer IP header is used to indicate that the traffic in the packets is non-L4S traffic regardless of the level of congestion for the telecommunications network 203. For example, the bits in the ECN field of the outer IP header are by default set to be “00” corresponding to the codepoint Not-ECT to indicate non-L4S capable transport.

The first apparatus 200 may then transmit packets that include L4S traffic and packets that include non-L4S traffic to the second apparatus 201 via the telecommunications network 203. Upon receiving packets from the first apparatus 200, the second apparatus 201 may provide the packets that include L4S traffic to a first queue and provide packets that include non-L4S traffic to a second queue. For example, the L4S traffic and the non-L4S traffic may be provided to a respective queue based on DSCP values, codepoints of the ECN field, and/or other indicators of the type of traffic in the outer IP header of received packets.

In the example shown in FIG. 2, the second apparatus 201 includes an L4S congestion control function 204. The L4S congestion control function 204 of the second apparatus 201 may determine whether one or more bits of the outer IP header of received packets indicate congestion is experienced for the telecommunications network 203. In response to the one or more bits of the outer IP header for a packet indicating that congestion is experienced for the telecommunications network 203, the L4S congestion control function 204 of the second apparatus 201 may implement one or more processes for L4S congestion control. For example, if one or more packets are marked with the first codepoint in the ECN field of the outer IP header, the L4S congestion control function 204 of the second apparatus 201 may implement one or more processes including, but not limited to, queuing, delaying, deprioritizing, and/or dropping packets.

In some embodiments, the second apparatus 201 may also determine whether a congestion level of the telecommunications network 203 exceeds a threshold in a manner similar to that described herein with respect to the first apparatus 200. In response a determination that the congestion level of the telecommunications network 203 exceeds the threshold, the L4S congestion control function 204 of the second apparatus 201 may implement one or more processes for L4S congestion control for the packets marked with the first codepoint or the second codepoint in the ECN field. However, the second apparatus 201 need not mark the inner packets to indicate that congestion is experienced for the telecommunications network 203 (e.g., using the ECN field of the inner IP packet or the SCTP packet).

For the opposite direction of communication (e.g., from the second apparatus 201 to the first apparatus 200), the operations described above may be reversed. For example, the L4S marking function 202 of the second apparatus 201 may mark outer IP headers of packets in a manner similar to that described herein and transmit packets to the first apparatus 200, and the L4S congestion control function 204 of the first apparatus 200 may implement one or more processes for L4S congestion control in a manner similar to that described herein.

In some embodiments, the first apparatus 200 and the second apparatus 201 may be endpoints of a GTP tunnel for the telecommunications network 203. For example, the first apparatus 200 may comprise a UPF or a PGW, and the second apparatus 201 may comprise a base station (e.g., a gNB). In some embodiments, the first apparatus 200 and the second apparatus 201 may be endpoints for internal signaling communications of the telecommunications network sent via SCTP packets. For example, the first apparatus 200 may comprise a network function and the second apparatus 201 may comprise a different network function or a base station. The first apparatus 200 and/or second apparatus 201 may also comprise a different component of the telecommunications network 203 (e.g., a switch or a router) depending on capabilities.

In the embodiment shown in FIG. 2, the first apparatus 200 and the second apparatus 201 optionally include an L4S feedback function 206. In some embodiments, the L4S feedback function 206 of the first apparatus 200 and/or the second apparatus 201 provides L4S feedback to a source of the inner packet indicating that congestion is experienced for the telecommunications network 203 in response to the one or more bits of the outer IP header indicating that congestion is experienced for the telecommunications network 203 or a determination by the first apparatus 200 and/or the second apparatus 201 that congestion is experienced for the telecommunications network 203. For example, the first apparatus 200 or the second apparatus 201 may provide feedback in response to the L4S marking function 202 marking packets to indicate that congestion is experienced and/or in response to receiving marked packets that indicate congestion is experienced for the telecommunications network 203.

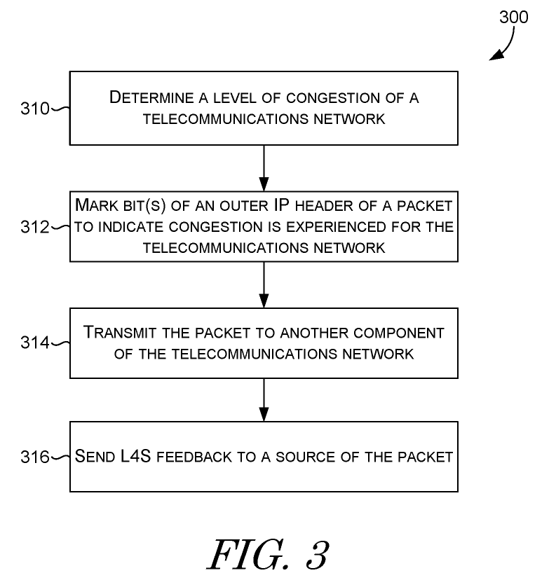

Referring to FIG. 3, an example method 300 is provided for native L4S operation in a telecommunications network, in accordance with some embodiments of the present disclosure. It should be understood that the features and elements described herein with respect to the method 300 of FIG. 3 may be used in conjunction with, in combination with, or substituted for elements of, any of the other embodiments discussed herein and vice versa. Further, it should be understood that the functions, structures, and other descriptions of elements for embodiments described in FIG. 3 may apply to like or similarly named or described elements across any of the figures and/or embodiments described herein and vice versa.

At block 310, a level of congestion of a telecommunications network is determined. The level of congestion may be determined based on a queue delay, a channel quality indicator (CQI), and/or other factors indicative of congestion for the telecommunications network. In some embodiments, the level of congestion is determined by a component of the telecommunications network.

At block 312, one or more bits of an outer IP header of a packet are marked to indicate congestion is experienced for the telecommunications network. The one or more bits of the outer IP header of the packet (e.g., L4S bits in the ECN portion of the outer IP header) may be marked based at least on a determined level of congestion. For example, the one or more bits of the outer IP header of the packet may be marked in response to the level of congestion exceeding a threshold. The outer IP header encapsulates an inner packet, which may comprise, for example, a user IP packet or an SCTP packet.

At block 314, the packet is transmitted to another component of the telecommunications network. The packet may comprise a GTP packet including a user IP packet encapsulated within the outer IP header, a UDP header, and a GTP header (e.g., GTP-U header), and the GTP packet may be transmitted via a GTP tunnel. In some embodiments, the packet may comprise the outer IP header that encapsulates an SCTP packet.

At block 316, feedback is optionally provided to a source of the packet indicating that congestion is experienced for the telecommunications network. In some embodiments, the feedback is provided to the source of the inner packet in response to the one or more bits of an outer IP header of a packet being marked or a determination that the level of congestion exceeds a threshold.

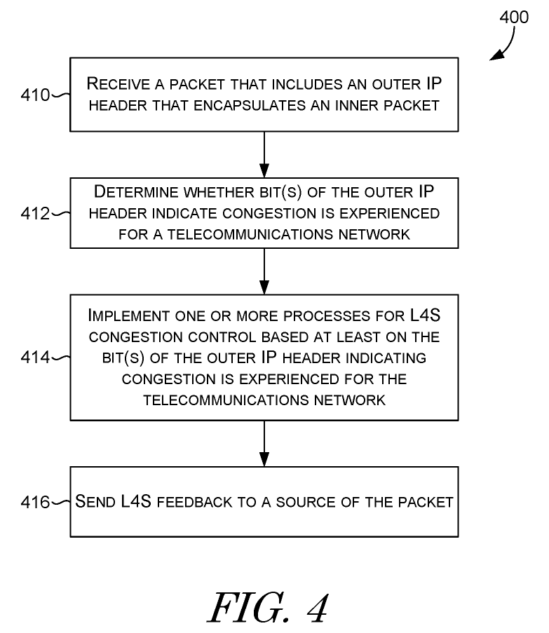

Referring to FIG. 4, an example method 400 is provided for native L4S operation in a telecommunications network, in accordance with some embodiments of the present disclosure. It should be understood that the features and elements described herein with respect to the method 400 of FIG. 4 may be used in conjunction with, in combination with, or substituted for elements of, any of the other embodiments discussed herein and vice versa. Further, it should be understood that the functions, structures, and other descriptions of elements for embodiments described in FIG. 4 may apply to like or similarly named or described elements across any of the figures and/or embodiments described herein and vice versa.

At block 410, a packet that includes an outer IP header that encapsulates an inner packet is received. The packet may comprise a GTP packet that may include the outer IP header, a UDP header, and a GTP header (e.g., a GTP-U header) encapsulating an inner user IP packet. The component of the telecommunications network that receives the GTP packet may comprise a base station, a PGW, or a UPF. In some embodiments, the packet comprises an SCTP packet that is encapsulated within the outer IP header. The component receiving the SCTP packet encapsulated in the outer IP header may comprise a base station or a network function of the core network.

At block 412, it is determined whether one or more bits of the outer IP header of the packet indicate that congestion is experienced for the telecommunications network. The one or more bits of the outer IP header that indicate that congestion is experienced for the telecommunications network may be included in the ECN field of the outer IP header. In some embodiments, the bits in the ECN field of the outer IP header may be marked “11” to indicate that congestion was experienced in the telecommunications network. The bits in the ECN field of the outer IP header may be marked “01” to indicate L4S-capable transport, but this does not indicate that congestion is experienced for the telecommunications network.

At block 414, one or more processes for L4S congestion control are implemented based at least on the determination of whether one or more bits of the outer IP header indicate that congestion is experienced for the telecommunications network. In some embodiments, the one or more processes L4S congestion control include, but are not limited to, queueing, delaying, deprioritizing, or dropping packets.

At block 416, feedback is optionally provided to a source of the packet indicating that congestion is experienced for the telecommunications network. The feedback may be provided to the source of the inner packet in response to a determination that the one or more bits of an outer IP header of the packet indicate that congestion is experienced for the telecommunications network or in response to implementing the one or more processes for L4S congestion control. In some embodiments, the feedback may be provided using a single packet and piggybacking on a communication being sent to the source of the inner packet.

Referring to FIG. 5, a diagram is depicted of an exemplary computing environment suitable for use in implementations of the present disclosure. In particular, the exemplary computer environment is shown and designated generally as computing device 500. Computing device 500 is but one example of a suitable computing environment and is not intended to suggest any limitation as to the scope of use or functionality of the embodiments described herein. Neither should computing device 500 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 5, the computing device 500 includes bus 510 that directly or indirectly couples one or more of the following devices: memory 512, one or more processors 514, one or more presentation components 516, input/output (I/O) ports 518, I/O components 520, power supply 522, and radio 524. Bus 510 represents what may be one or more busses (such as an address bus, data bus, or combination thereof). The components of FIG. 5 are shown with lines for the sake of clarity. However, it should be understood that the functions performed by one or more components of the computing device 500 may be combined or distributed amongst the various components. For example, a presentation component such as a display device may be one of I/O components 520. In some embodiments, a base station, RAN and/or component of the core network implementing one or more aspects of an apparatus (e.g., first apparatus 200 or second apparatus 201) comprise a computing device 500. In some embodiments, the first device 101 or the second device 102 from FIG. 1 may comprise a computing device such as the computing device 500.

The processors of the computing device 500, such as the one or more processors 514, have memory. The present disclosure hereof recognizes that such is the nature of the art, and reiterates that FIG. 5 is merely illustrative of an exemplary computing environment that can be used in connection with one or more implementations of the present disclosure. Distinction is not made between such categories as “workstation,” “server,” “laptop,” “handheld device,” etc., as all are contemplated within the scope of FIG. 5 and refer to “computer” or “computing device.”

The computing device 500 typically includes a variety of computer-readable media. Computer-readable media can be any available non-transient media that can be accessed by computing device 500 and includes both volatile and nonvolatile media, removable and non-removable media. By way of example, and not limitation, computer-readable media may comprise computer storage media and communication media. Computer storage media includes both volatile and nonvolatile, removable and non-removable non-transient media implemented in any method or technology for storage of information such as computer-readable instructions, data structures, program modules or other data.

Computer storage media includes non-transient RAM, ROM, EEPROM, flash memory or other memory technology, CD-ROM, digital versatile disks (DVD) or other optical disk storage, magnetic cassettes, magnetic tape, magnetic disk storage or other magnetic storage devices. Computer storage media and computer-readable media do not comprise a propagated data signal or signals per se.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 512 includes tangible, non-transient, computer-storage media in the form of volatile and/or nonvolatile memory. The memory 512 may be removable, non-removable, or a combination thereof. Exemplary memory includes solid-state memory, hard drives, optical-disc drives, etc. The computing device 500 includes one or more processors 514 that read data from various entities such as the bus 510, the memory 512 or the I/O components 520. One or more presentation components 516 may present data indications to a person or other device. Exemplary one or more presentation components 516 include a display device, speaker, printing component, vibrating component, etc. The I/O ports 518 allow computing device 500 to be logically coupled to other devices including the I/O components 520, some of which may be built in the computing device 500. Illustrative I/O components 520 include a microphone, joystick, game pad, satellite dish, scanner, printer, wireless device, etc.

The radio(s) 524 represent a radio that facilitates communication with a wireless telecommunications network. For example, radio(s) 524 may be used to establish communications with a UE and/or a RAN. Illustrative wireless telecommunications technologies include CDMA, GPRS, TDMA, GSM, 4G LTE, 3GPP 5G, and other 3GPP technologies. The radio(s) 524 may additionally or alternatively facilitate other types of non-3GPP wireless communications including Wi-Fi, WiMAX, and/or other VoIP communications. In some embodiments, the radio(s) 524 may support multi-modal connections that include a combination of 3GPP radio technologies (e.g., 4G, 5G and/or 6G) and/or non-3GPP radio technologies. As can be appreciated, in various embodiments, the radio(s) 524 can be configured to support multiple technologies and/or multiple radios can be utilized to support multiple technologies. In some embodiments, the radio(s) 524 may support communicating with an access network comprising a terrestrial wireless communications base station and/or a space-based access network (e.g., an access network comprising a space-based wireless communications base station). A wireless telecommunications network might include an array of devices, which are not shown so as to not obscure more relevant aspects of the embodiments described herein. Components such as a base station, a communications tower, or even access points (as well as other components) can provide wireless connectivity in some embodiments.

As used herein, the terms “function”, “unit”, “server”, “node” and “module” are used to describe computer processing components and/or one or more computer executable services being executed on one or more computer processing components. In the context of this disclosure, such terms used in this manner would be understood by one skilled in the art to refer to specific network elements and not used as nonce word or intended to invoke 35 U.S.C. 112(f).

Many different arrangements of the various components depicted, as well as components not shown, are possible without departing from the scope of the claims below. Embodiments in this disclosure are described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

In the preceding detailed description, reference is made to the accompanying drawings which form a part hereof wherein like numerals designate like parts throughout, and in which is shown, by way of illustration, embodiments that may be practiced. It is to be understood that other embodiments may be utilized and structural or logical changes may be made without departing from the scope of the present disclosure. Therefore, the preceding detailed description is not to be taken in the limiting sense, and the scope of embodiments is defined by the appended claims and their equivalents.

What is claimed is:

1. An apparatus, comprising:
one or more processors; and
one or more computer-readable media storing computer-usable instructions that, when executed by the one or more processors, cause the one or more processors to:
receive a packet that includes an outer Internet Protocol (IP) header that encapsulates an inner packet;
determine whether one or more bits of the outer IP header indicate congestion is experienced for a telecommunications network; and
implement one or more processes for Low Latency, Low Loss, and Scalable Throughput (L4S) congestion control based at least on the one or more bits of the outer IP header indicating that the congestion is experienced for the telecommunications network.

2. The apparatus of claim 1, wherein the apparatus includes a first queue for L4S traffic and a second queue for non-L4S traffic, wherein the packet is directed to the first queue.

3. The apparatus of claim 2, wherein the one or more processes for L4S congestion control include queuing, delaying, deprioritizing, and/or dropping packets.

4. The apparatus of claim 1, wherein the packet comprises a General Packet Radio Service (GPRS) Tunneling Protocol (GTP) packet including the outer IP header, a User Datagram Protocol (UDP) header, and a GTP header, wherein the inner packet comprises a user IP packet.

5. The apparatus of claim 1, wherein the computer-usable instructions, when executed by the one or more processors, further cause the one or more processors to provide L4S feedback to a source of the inner packet indicating that congestion is experienced for the telecommunications network.

6. The apparatus of claim 1, wherein the inner packet comprises a Stream Control Transmission Protocol (SCTP) packet.

7. The apparatus of claim 1, wherein the apparatus comprises a network function, an access node, or a switch of the telecommunications network.

8. The apparatus of claim 1, wherein the packet includes L4S traffic, wherein the computer-usable instructions, when executed by the one or more processors, further cause the one or more processors to:
determine whether a congestion level for the telecommunications network exceeds a threshold; and
implement the one or more processes for L4S congestion control for the packet based a determination that the congestion level for the telecommunications network exceeds the threshold.

9. An apparatus, comprising:
one or more processors; and
one or more computer-readable media storing computer-usable instructions that, when executed by the one or more processors, cause the one or more processors to:
mark one or more bits of an outer Internet Protocol (IP) header of a packet to indicate that congestion is experienced in a telecommunications network that includes the apparatus, wherein the outer IP header encapsulates an inner packet; and
transmit the packet to another component of the telecommunications network.

10. The apparatus of claim 9, wherein the packet comprises a General Packet Radio Service (GPRS) Tunneling Protocol (GTP) packet including the outer IP header, a User Datagram Protocol (UDP) header, and a GTP header, wherein the inner packet comprises a user IP packet.

11. The apparatus of claim 9, wherein the computer-usable instructions, when executed by the one or more processors, further cause the one or more processors to provide Low Latency, Low Loss, and Scalable Throughput (L4S) feedback to a source of the inner packet indicating that congestion is experienced for the telecommunications network.

12. The apparatus of claim 9, wherein the inner packet comprises a Stream Control Transmission Protocol (SCTP) packet.

13. The apparatus of claim 9, wherein the apparatus comprises a network function or an access node of the telecommunications network.

14. The apparatus of claim 9, wherein the computer-usable instructions, when executed by the one or more processors, further cause the one or more processors to determine a congestion level based at least on one or more network characteristics.

15. The apparatus of claim 14, wherein the computer-usable instructions, when executed by the one or more processors, cause the one or more processors to mark the one or more bits of the outer IP header of the packet to indicate that congestion is experienced in the telecommunications network that includes the apparatus in response to the congestion level exceeding a threshold.

16. The apparatus of claim 9, wherein the computer-usable instructions, when executed by the one or more processors, cause the one or more processors to:
receive a second packet that includes an outer IP header that encapsulates a second inner packet;
determine whether one or more bits of the outer IP header indicate congestion is experienced for the telecommunications network; and
implement one or more processes for Low Latency, Low Loss, and Scalable Throughput (L4S) congestion control for the second packet based at least on the one or more bits of the outer IP header indicating that congestion is experienced for the telecommunications network.

17. A method, comprising:
marking, with a first component of a telecommunications network, one or more bits of a field of an outer Internet Protocol (IP) header of a packet to indicate that the packet includes Low Latency, Low Loss, and Scalable Throughput (L4S) traffic or to indicate that congestion is experienced for the telecommunications network, wherein the outer IP header encapsulates an inner packet; and
transmitting the packet to a second component of the telecommunications network.

18. The method of claim 17, wherein the packet comprises a General Packet Radio Service (GPRS) Tunneling Protocol (GTP) packet including the outer IP header, a User Datagram Protocol (UDP) header, and a GTP header, wherein the inner packet comprises a user IP packet.

19. The method of claim 17, wherein the inner packet comprises a Stream Control Transmission Protocol (SCTP) packet.

20. The method of claim 17, further comprising determining whether the congestion is experienced for the telecommunications network based at least on one or more network characteristics exceeding a threshold.
